(19) United States
(12) Patent Application Publication
(10) Pub. No.: US 2010/0120492 A1
(43) Pub. Date: May 13, 2010

(54) ENHANCING WIN OUTCOME DISPLAY WITH FICTITIOUS LOSSES

(75) Inventors: Wesley Steven Davis, Notre-Dame (CA); Eric Michael Loat, Moncton (CA); Daniel Malcolm Urquhart, Moncton (CA); Stephane Gerald Edouard Caissie, St-Antoine (CA)

Correspondence Address: SULLIVAN & WORCESTER LLP, 1666 K Street NW, Washington, DC, 20006, US

(73) Assignee: SPIELO MANUFACTURING ULC, Moncton (CA)

(21) Appl. No.: 12/267,354

(22) Filed: Nov. 7, 2008

(51) Int. Cl. A63F 9/24; A63F 13/00

(52) U.S. Cl. 463/20

(57) ABSTRACT

A method of facilitating the operation of a wagering game and a system for operating the same. A winning game outcome may be randomly determined. The display of the winning game outcome to a player may be accomplished by first displaying a fictitious loss, and then visually transforming the display of the fictitious loss into a display representing the winning game outcome.

### BACKGROUND

Video gaming machines such as slot machines or video poker have long been a staple for the gaming industry. Often times game establishments are limited in the number of machines they are able to provide; either due to floor space limitations or government regulation. For this reason it is important to maximize the profitability of each individual machine. For example, one player on one machine betting a dollar per play is as profitable as twenty players on twenty machines betting a nickel per play.

The profitability of a machine for operators is directly related to how popular that machine is to players. Competition for a more popular design among manufacturers is high, and a more popular game provides a substantial marketplace advantage. Popularity of a machine is often a function of both the perceived likelihood of winning and the entertainment value of the game itself.

One method of increasing both entertainment value and perceived likelihood of winning is the prevalent use of a dazzling presentation when granting a win or a special bonus win. However, as impressive as a video presentation may be, at a basic emotional level a player inevitably feels that it is the “player versus the machine” or the “player versus the casino.” Moreover, because the most visually appealing and interesting parts of games may be provided in bonus rounds, the underlying game mathematics may limit the frequency that the visually most interesting parts of the game are actually displayed, potentially reducing player enjoyment.

### BRIEF DESCRIPTION OF THE DRAWINGS

Example embodiments of the invention are illustrated by way of example, and not by way of limitation, in the figures of the accompanying drawings and in which like reference numerals refer to similar elements.

FIG. 1A illustrates a block diagram of an example gaming terminal, according to an example embodiment of the present invention.

FIG. 1B illustrates an example gaming terminal, according to an example embodiment of the present invention.

FIG. 2 illustrates an example distributed system including a multiple of distributed gaming terminals, according to an example embodiment of the present invention.

FIG. 3 illustrates a flowchart of an example procedure for facilitating the operation of a wagering game, according to another example embodiment of the present invention.

FIG. 4 illustrates a flowchart for an alternative example procedure, according to another example embodiment of the present invention.

FIG. 5 illustrates a flowchart for an example presentation enhancement procedure in an example game, according to an example embodiment of the present invention.

FIG. 6A illustrates an example animated enhanced presentation, according to an example embodiment of the present invention.

FIG. 6B illustrates a second example animated enhanced presentation, according to an example embodiment of the present invention.

FIG. 6C illustrates a third animated enhanced presentation, according to an example embodiment of the present invention.

FIG. 6D illustrates a fourth animated enhanced presentation, according to an example embodiment of the present invention.

FIG. 6E illustrates a fifth animated enhanced presentation, according to an example embodiment of the present invention.

FIG. 6F illustrates a sixth animated enhanced presentation, according to an example embodiment of the present invention.

FIG. 6G illustrates a seventh animated enhanced presentation, according to an example embodiment of the present invention.

FIG. 6H illustrates an eighth animated enhanced presentation, according to an example embodiment of the present invention.

### DETAILED DESCRIPTION OF EXAMPLE EMBODIMENTS

It would be desirable to increase the number and variety of “special” displays made to players, to allow greater visual entertainment and play value, without altering underlying game payout mathematics. Moreover, in some jurisdictions, regulations restrict the change of screens after a game spin, making it desirable to find ways to have bonus or enhanced games using an initially displayed game set of game symbols, without changing screens.

Also, if a particular machine in a gaming establishment were able to evoke a perception that it is a rogue—mysteriously giving away bonuses or wins to the player—such a game would likely be appealing to many players. However, such a game would need to remain legitimate and tasteful without any form of misrepresentation. And in some jurisdictions, this appearance may need to be obtained without changing the underlying game mathematics.

In some example embodiments of the present invention, a conventional video slot machine or other game using an animated display may be modified so that some wins are displayed in a new and exciting fashion. An initial display may be made, representing a loss (or perhaps a lesser win), and then after the loss (or lesser win) is displayed, the display is altered to produce a display of a win (or a larger win). This alteration may be made using a visual transformation that is interesting and entertaining to a player, e.g., in a video slot machine game by using an animated character or other animated effect that moves the already stopped reels, changes game symbols, or otherwise appears to alter the results of the game. This effect may be triggered as a bonus separate from the underlying reel mathematics, or alternatively may be applied with no change of the underlying game reel mathematics, e.g., by altering how certain results are displayed when predefined triggers occur.

It will be appreciated that, while the example embodiments are primarily described with reference to video slot machines with simulated spinning reels, similar types of effects may be provided in other sorts of wagering games, such as video poker games, video games simulating conventional casino games, etc.

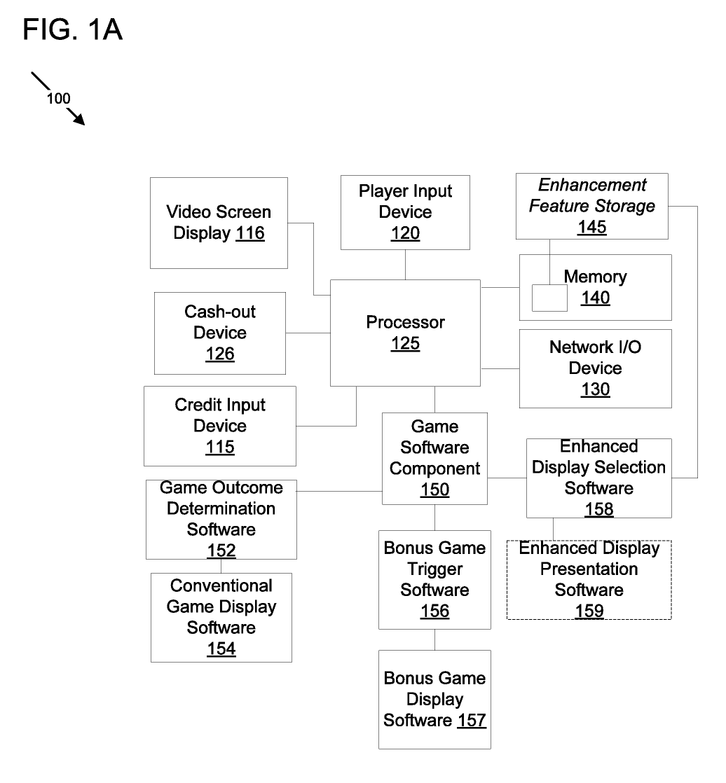

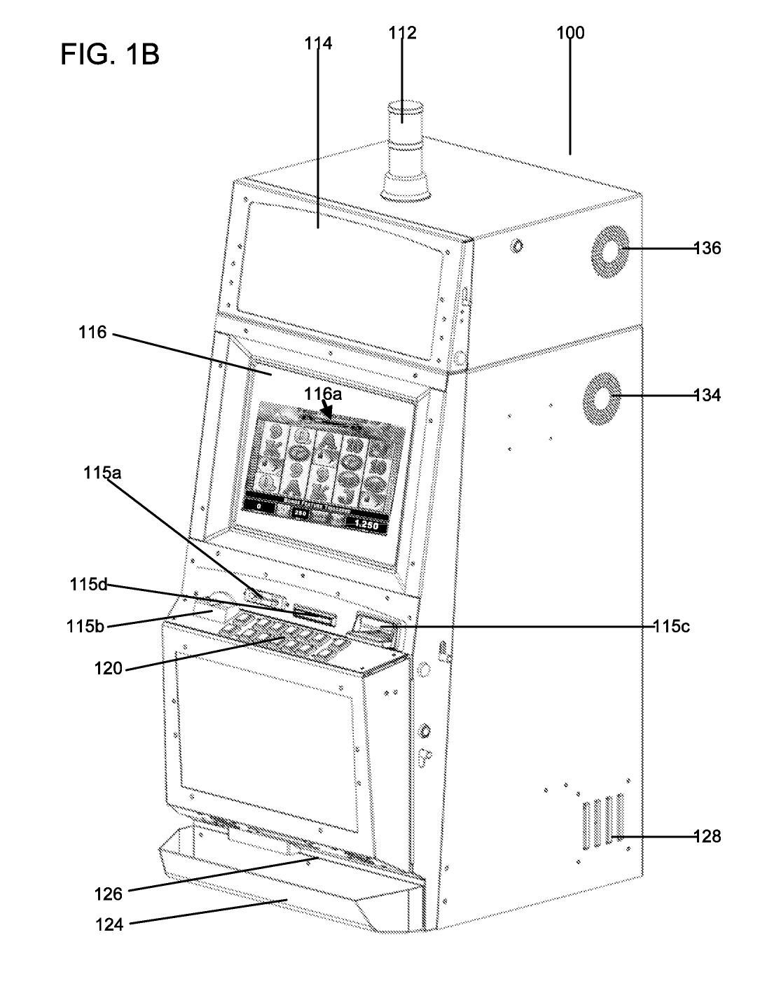

In the following description, for the purposes of explanation, specific details are set forth in order to provide a thorough understanding of some example embodiments of the invention. However, it will be apparent that the invention can be practiced without these specific details, and is only limited by the claims. Section titles and references appearing within the following paragraphs are intended for the convenience of the reader and should not be interpreted to restrict the scope of the information presented at any given location. This section describes the figures and several example embodiments in greater detail. Figures are numbered and the elements of figures all begin with the figure number followed by the element number. For example, element 10 of FIG. 1 will be labeled 110.

FIG. 1A illustrates a block diagram of an example gaming terminal 100, according to an example embodiment of the present invention. The gaming terminal 100 may include a video screen display 116. The video screen display may display the game graphics and may have variable control settings. The video screen display may also have, for example, touch-screen buttons for player input. The gaming terminal 100 may also include a player input device 120. The player input device 120 may be any device which allows the gaming terminal 100 to accept input from the user, for example, a conventional keyboard, an external number keypad, a joystick, a mouse, or the video display itself may accept touch-screen input. The gaming terminal 100 may also include a credit input device 115. The credit input device 115 may be designed, for example, to accept paper bills, or other slips detailing credit, or may be a device which reads magnetically or electronically stored information. Terminal 100 may also include a processor 125. The processor 125 may be, for example, a CPU or microprocessor. The terminal 100 may also include a network I/O device 130. The network I/O device 130 may be, for example, a serial port which may connect to a telephone line. The game terminal 100 may also include memory 140 to store the various graphics and instructions required to operate video screen display 116. Memory 140 may also allocate storage 145 to keep track of some value or set of values during game play used to track and control the enhanced presentation features described in the present application. Alternatively, storage 145 may be a separate piece of hardware, independent of the main set of memory 140, e.g., information stored on a server in network communication with the game terminal.

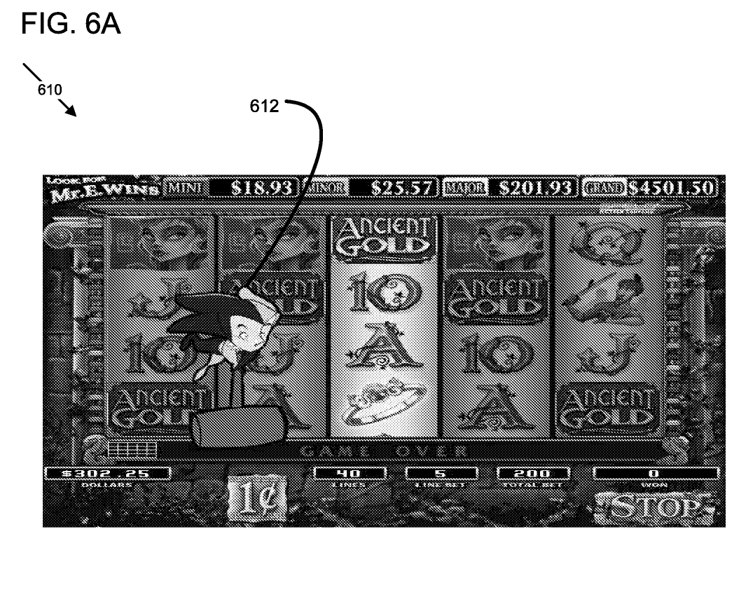

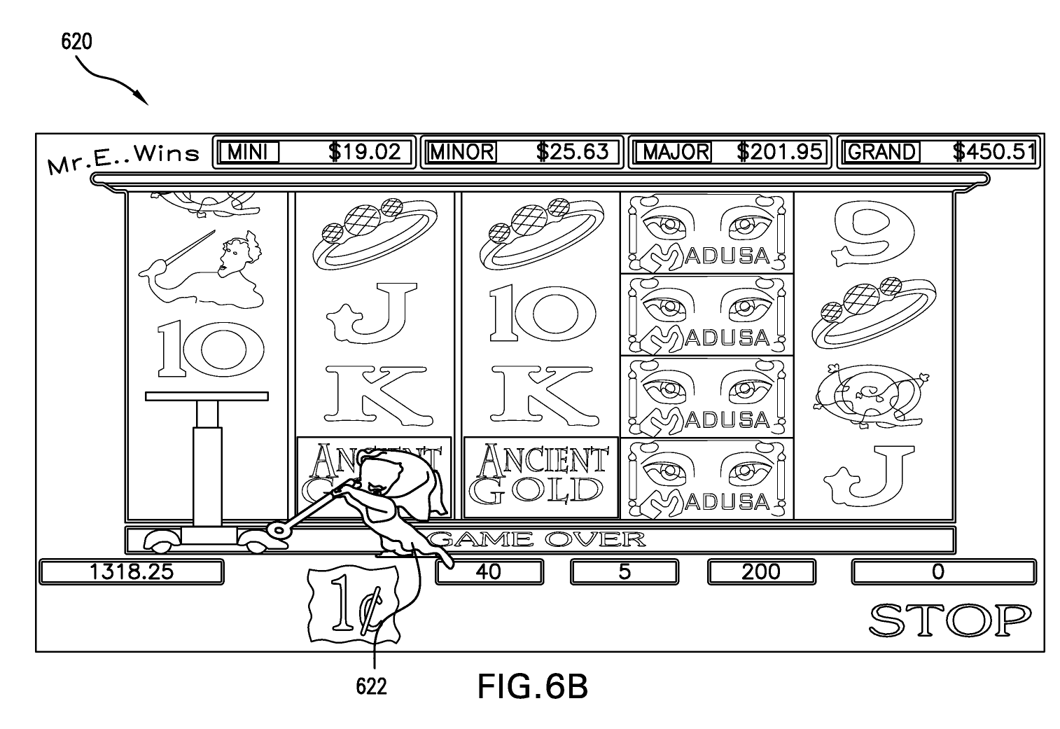

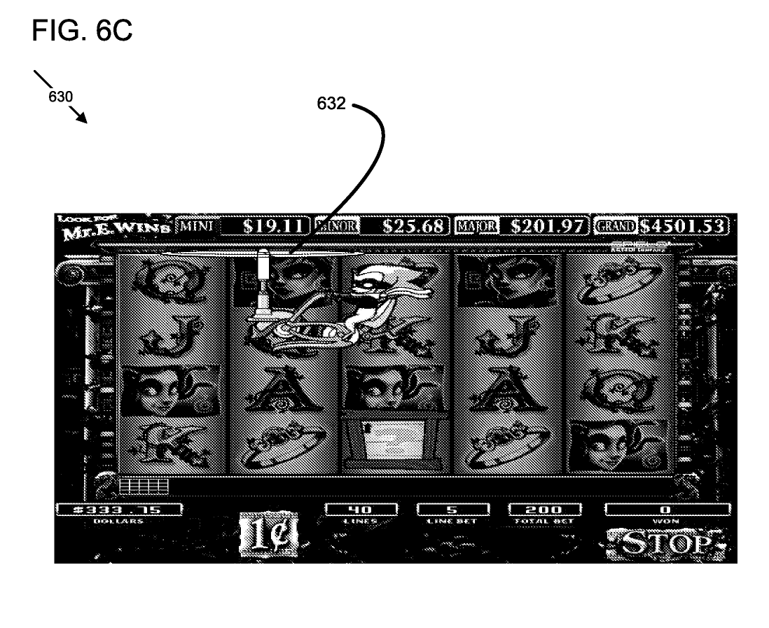

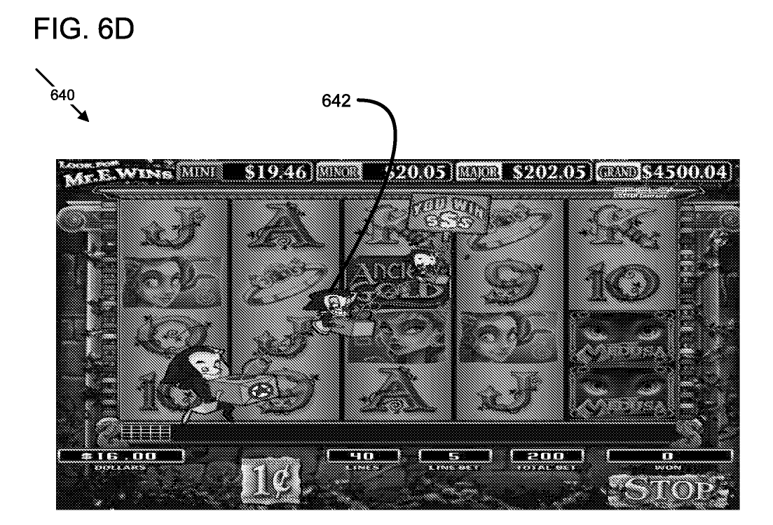

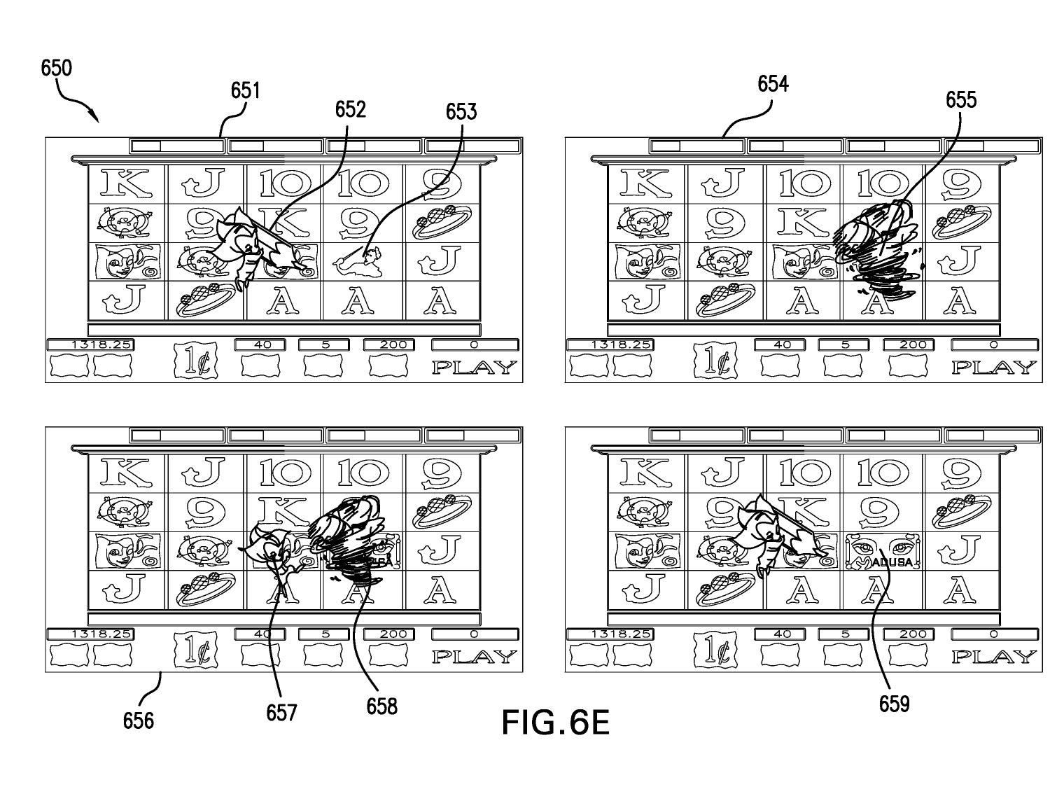

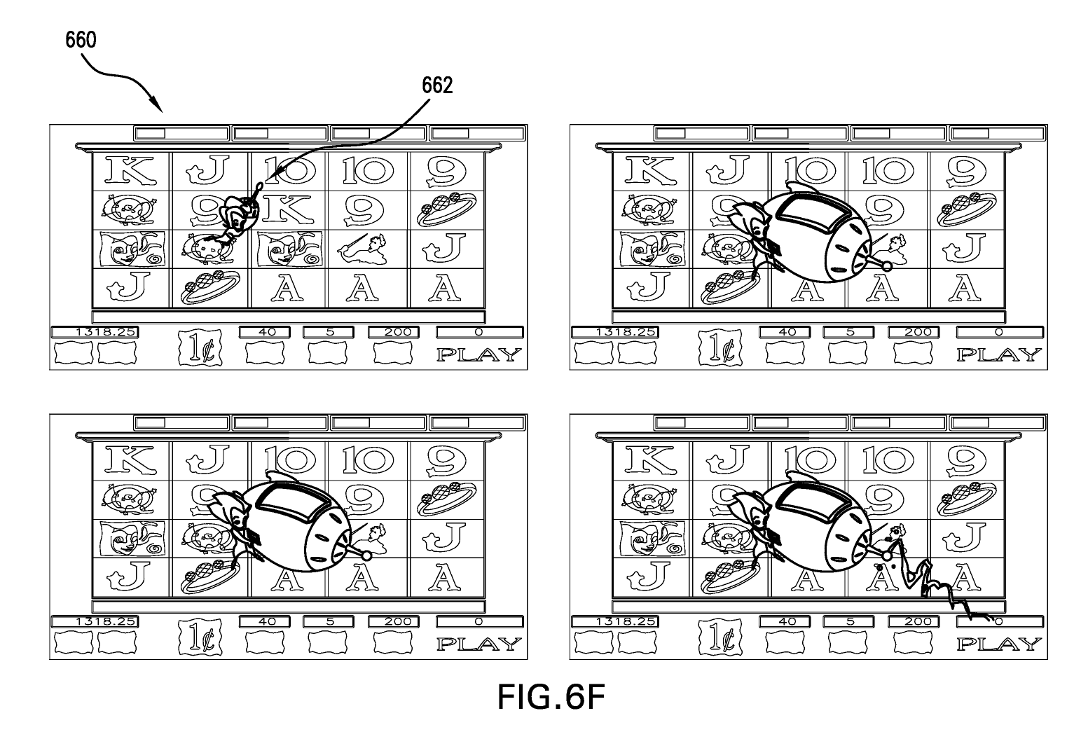

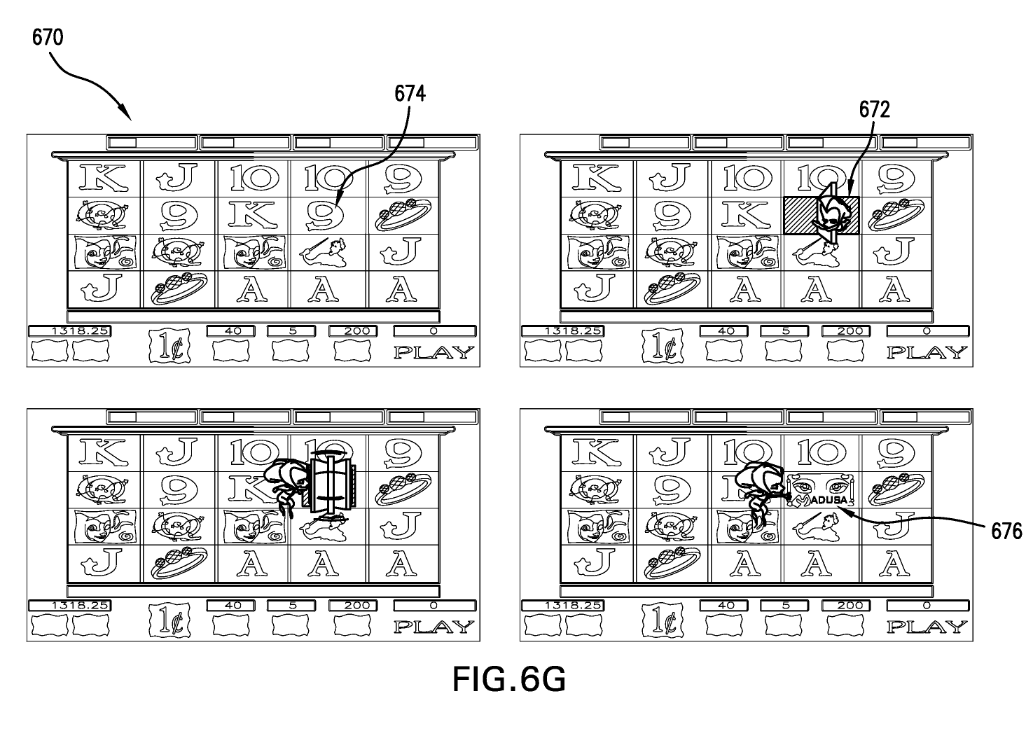

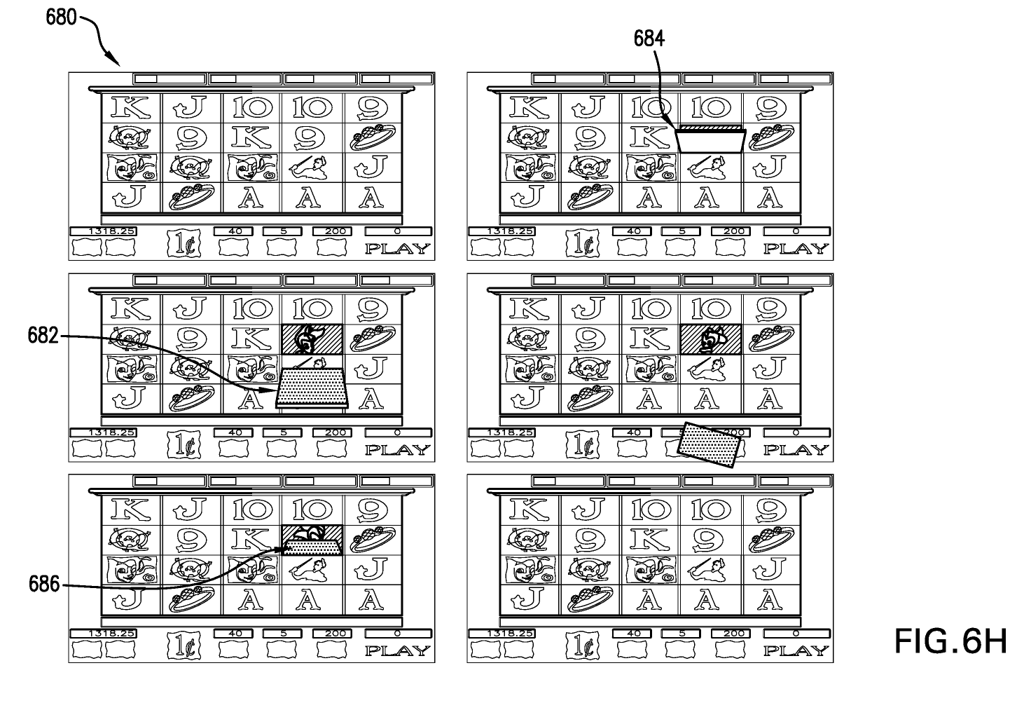

The example gaming terminal 100 may also include a game software component 150. The game software component may contain instructions for executing both conventional game procedures, as well as the example game procedures and methods described below. The game software component 150 may be stored in memory 140, a server, a disk, or any other device capable of being accessed by processor 125. The game software component 150 may have or be in communication with software components configured to determine game outcomes 152 in a conventional manner and to software components configured to display a regular game in a convention manner 154. The regular game display software 154 may also include or be in communication with software to display a bonus presentation 157 or an enhanced presentation 154, e.g., the presentation of a fictitious loss that is visually transformed into the appropriate winning outcome discussed below (e.g. the animations illustrated in FIG. 6).

The game software component 150 may have bonus game triggering software 156. The game software component 150 may have bonus game display software 158, which may be executed responsive to the bonus trigger 156. The bonus game display software 157 may have an optional software component which may be used to allow the player to select the level and/or nature of the bonus prize enhancement.

The game software component may also have or be in communication with enhanced display selection software component 158 that is configured to determine whether and when to display an enhanced win display for game outcomes, e.g., particular game wins. Information needed to make this determination may be stored in and accessed from the enhancement feature storage 145. When triggered by the enhanced display selection software component 158, an enhanced display presentation software 159 may provide an enhanced display of a win, e.g., the display of a fictitious loss that is visually transformed into the determined win, as described in the procedures below.

It should be appreciated that any of these software components 150-159 may be directly accessible by the processor 125, accessible remotely through the network I/O device 130, accessible through the memory 140 (as being stored in memory 140), or through any other device capable of being accessed by the processor 125 (e.g. a disk and disk-drive). The software components 152-159 may be part of the game software component 150 or each other, or may be independent components accessible by processor 125.

It will be appreciated that, while the example system has been illustrated as a single uniprocessor system, that various distributed, multi-processor, client-server, or networked implementations could also be provided.

FIG. 1B illustrates an example game terminal 100, in accordance with an example embodiment of the present invention. A terminal 100 may be configured to conduct a wagering game, e.g., using the functional components illustrated in FIG. 1A. For example, a wagering game may be a slot machine game, lottery, a video game, or another game of chance involving a wager. For example, the terminal 100 may be a video poker game terminal, a video wagering game terminal, a video slot machine, or a video game terminal. While a video terminal has been illustrated, other embodiments such as a fixed slot machine with actual reels could be used. The terminal may provide games as a dedicated stand alone terminal, as a software application on a more general purpose terminal or computer, or via a network, e.g., over the Internet or in a client-server application.

The terminal 100 may include a blinker 112. The blinker 112 may enclose a light configured to blink on and off. For example, the blinker 112 may be configured to blink when a large prize is awarded from the terminal 100. This may occur independent of, or in coordination with the enhanced presentations of the present application being presented on the terminal screen.

The terminal 100 may include a lighted display 114. For example, the lighted display 114 may include a logo, a game name or other visually attractive graphics or advertising. The lighted display 114 may alternatively be a liquid crystal display screen or any other visual display device.

The terminal 100 may include display screen 116. The display screen 116 may be a liquid crystal display screen (LCD), a cathode ray tube (CRT) screen, a plasma display, or any other visual display device. For example, the display screen 116 may enclose a viewable display area visible to a player. Alternatively, the display screen 116 may be a touch screen, able to accept player inputs caused by touching the screen. Display screen 116 may be configured to display an example game of an example embodiment of the present invention (e.g. as illustrated in FIG. 1B, display element 116, and similarly in FIGS. 6A-6H). The example game may display an example enhancement indicator 116a (e.g. as seen in FIGS. 6A-6H).

The terminal 100 may include a credit card acceptor 115a, a player's card acceptor 115d and a currency acceptor 115c and 115b. For example, the credit card acceptor 115a may accept a credit card or a debit card for a player's wager, or to load credits into a “bank” or credit account for future wagers. For example, the player's card acceptor 115d may accept a frequent player's card. The frequent player's card may include a player's identifying information and wager history. Alternatively, the frequent player's card may include an identifier that is associated with a player's identifying information and wager history. The frequent player's card may be configured to store credit information, allowing a player to move the “bank” associated with the player from one terminal to another, or to the same terminal later. The currency acceptor 115c may be configured to accept cash bills in various denominations for a player's wager (or for the “bank” to be wagered later), and 115b may be configured to accept cash coins in various denominations.

The terminal 100 may include input modules 120. For example, the input modules 120 may be a set of buttons. The input modules 120 may be configured to receive input from a player during a wagering game.

The terminal 100 may include a dispenser tray 124 and a dispenser 126. The dispenser 126 may be configured to dispense a prize. For example, a prize may be currency or a prize receipt redeemable at a cashier. The dispenser tray 124 may be configured to catch the prize after it is dispensed.

The terminal 100 may include openings 128, 134 and 136. Opening 128 may be configured to allow ambient air to circulate into and out of an interior of the terminal 100. Openings 134 and 136 may be configured to allow sound through.

While FIG. 1B may illustrate a dedicated electronic slot machine, the example games, procedures, and functions, as well as similar games procedures, and functions may also be provided on various other devices. These devices may be stand alone or be distributed. These devices may run any number of wagering games, such as a video poker game, a lottery game, or any other conventional wagering game, either in a standard way, or with the enhancement win displays described herein. Even games typically reserved as “table games” such as craps or roulette may implement the example methods or systems described here. The games may also be provided on a variety of other devices such as a cell phone, a PDA, a computer connected to a network (e.g. the in house network of a gaming establishment or the internet), or any other device capable of implementing the methods or systems described herein.

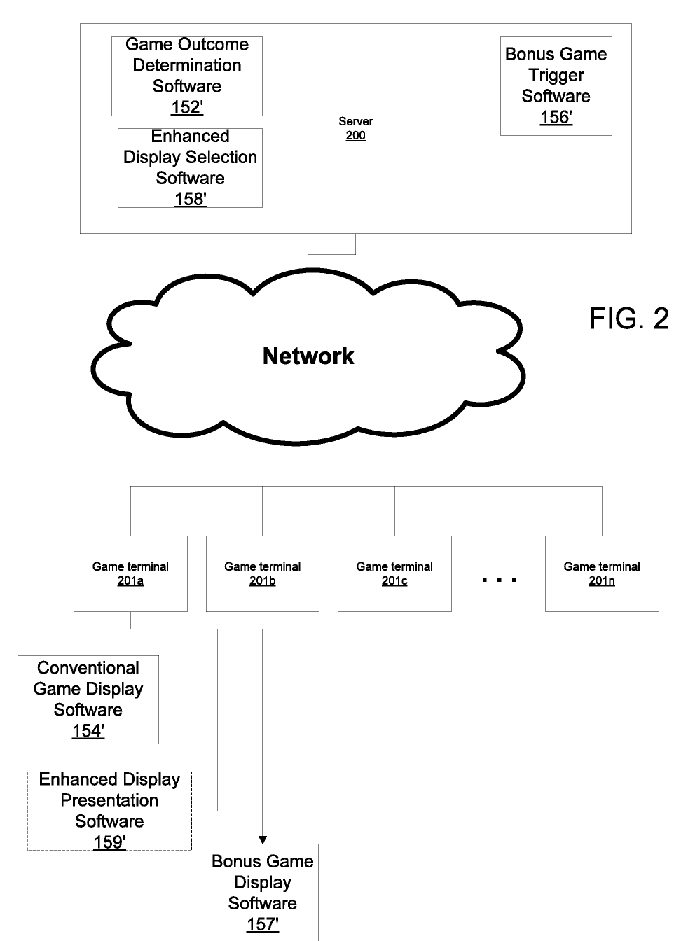

FIG. 2 illustrates an example networked gaming system, according to an example embodiment of the present invention. Using the network I/O device 130 described in FIG. 1, each game terminal 201a-n may be connected to a central server 200. In this example, terminals 201 may be the same as or similar to terminal 100 as described in FIG. 1. The gaming terminals may report certain status data, including security, exception, cash-out, and game play events, as necessary. Additionally, by connecting the terminals to a server 200 certain information may be stored in the server memory 210, and be accessed by any terminal 201g-201n. In this example embodiment player information could be accessed by the player no matter which terminal 201g-201n the player was using at any given time. While only one server and four terminals are shown in FIG. 2, it is appreciated that this system could run on any number of network topologies, distributions, or configurations and may accommodate any number of terminals 201g-201n. In another example, a central server is not even needed as the networked terminals could run a peer-to-peer topology, either simulating a central server among themselves or fully distributing the group operation. The terminals may be wired, wireless, or configured in any conventional manner of implementing communication among the terminals and optional server.

In this example system, the outcome determination, decision to award a bonus, and decision to trigger an enhanced display are all made at the server and communicated to the various game terminals, e.g., by software components 152′; 156′; 158′ similar to the ones in the single terminal example, but run for each terminal upon request. The game terminals themselves may all share the same underlying game mathematics, or may operate with different parameters. The different terminals may also have different presentations on different types of terminals (or even multiple configurable types of presentations with the same underlying mathematics at a single terminal). At the same time, the presentations may be generated and displayed at the terminals, based on the various results communicated from the server to the terminals over the network. It will be appreciated that other arrangements of these features could be accomplished, e.g., some of these determinations, e.g., the game outcome, could be made at the server, while the decision to make an enhanced win presentation could be made at the terminal. Also presentations themselves could be stored and served from the server on demand to the terminals, although this would likely require a great deal of additional bandwidth in the network.

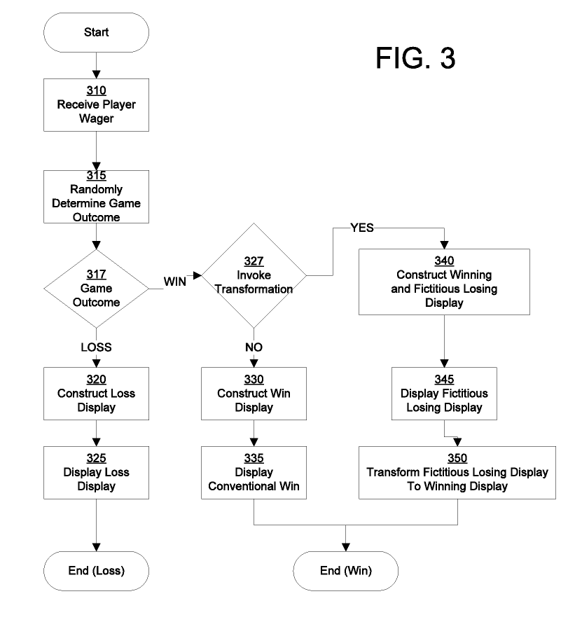

FIG. 3 illustrates an example procedure for facilitating the operation of a wagering game with a fictitious losing outcome, according to an example embodiment of the present invention. While the example procedure is described primarily in reference to a stand-alone video slot machine game, it will be appreciated that the example procedure may be provided using a wide variety of other systems, e.g., a server-based system, an Internet game, wagering games provided on personal computers, etc. Moreover, although the examples are described in part with reference to a video slot machine with simulated spinning reels, it will be appreciated that similar procedures may be used with many other types of wagering games, such as video simulations of conventional casino games, video poker, online keno or bingo games, etc.

In 310, a player wager may be received. The player may tender cash, credit, access prepaid funds, or wager credits stored on a gaming machine or server. The player may select an amount to wager, or a default amount may be wagered. The player may use any of a variety of approaches to signify they are ready to wager the selected amount and commit to the game, e.g., pulling a lever, pressing a button, sending an email, entering a command at a terminal, etc.

In 315 a random number or numbers may be determined, and based on this random number a random game outcome may be determined, generally through the use of a predetermined mapping between the random number and game results. For example, the random number may be used to choose a random entry in a prize table, either with or without replacement. The random number(s) may also be mapped to various elements of the game outcome, e.g., position of simulated video slot machine reels, drawings of playing cards, number drawings, simulated race results, etc., that when combined indicate the game result when the game rules are applied. It will be appreciated that, depending on the game implementation and also on the rules of the jurisdiction where the game is conducted, the mapping between the random numbers generated and the outcome may be direct or indirect. For example, the position of the slot machine reels may be randomly determined, indicating the prize. Alternatively, a result may be determined, and then an appropriate position of the slot machine reels to indicate the outcome may be chosen.

In 317, based on whether the outcome is a win or loss, different control paths may be taken. In 320, if the game outcome is a loss, a display indicating the loss may be assembled, e.g., the graphics for the losing position of slot machine reels may be retrieved for display or functions controlling the display of the simulated spinning reels may be instructed to stop at the randomly determined losing game outcome. In 325, the losing outcome may be displayed to the player, indicating to the player that the play of the game has ended in a loss. It will be appreciated that the procedure may also be modified to accommodate multiple rounds of plays, multiple pulls for a single wager, successive wagers, etc.

In 327, assuming the game outcome is a win, it may be determined whether to display the win in a natural way, according to the conventional rules of the game, or alternatively to use a fictitious loss or other enhanced win display. It will be appreciated that while illustrated here as a choice between a win or loss, alternative choices could be used. For example, enhanced presentations could be used to present winning results that turn into losing results, although that might frustrate rather than excite players. Various randomizations, triggers, or data could be used to decide whether to trigger an enhanced display

If a conventional display is used the procedure continues at 330. In 330, a display for the winning outcome may be constructed, e.g., by retrieving appropriate graphics for display. In 335, the winning game outcome may be displayed to the player in a conventional manner, and the game may end in a win. The player may collect the appropriate prize in a conventional manner, e.g., by having game credit added to an account or by receiving cash immediately from a game machine.

If an enhanced presentation, e.g., a fictitious loss, is to be displayed, the procedure continues at 340. In 340, a winning display may be constructed, along with a fictitious losing display. In 345, the fictitious losing display may be displayed to the player. It will be appreciated that, in some alternatives, the display need not be a losing display, but may merely be a display with an inferior result, e.g., a lesser prize, that is subsequently transformed into a display representing a greater prize.

In 350, the fictitious losing (or inferior) display may be visually transformed into the winning display that was randomly determined in 315 and constructed in 340. For example, game symbols in a displayed arrangement may be moved or replaced, by any of a large variety of approaches that a player may find exciting or entertaining, e.g., moving the slot machines reels, changing elements on slot machine reels, simulating cheating at cards allowing the player to see a card pulled from an animated players sleeve, nudging animated dice so they tip on another face, bumping the ball on an animated roulette wheel, or simulating a machine malfunction of some sort. Once the transformation is completed, the display corresponding to the winning outcome is displayed to the player. As in 335, the player may collect the prize for the finally displayed winning outcome in any conventional manner. Alternatively, an animated character may simply award the prize for the winning outcome to the player without transforming the fictitious losing display, e.g., by adding credits to the bank.

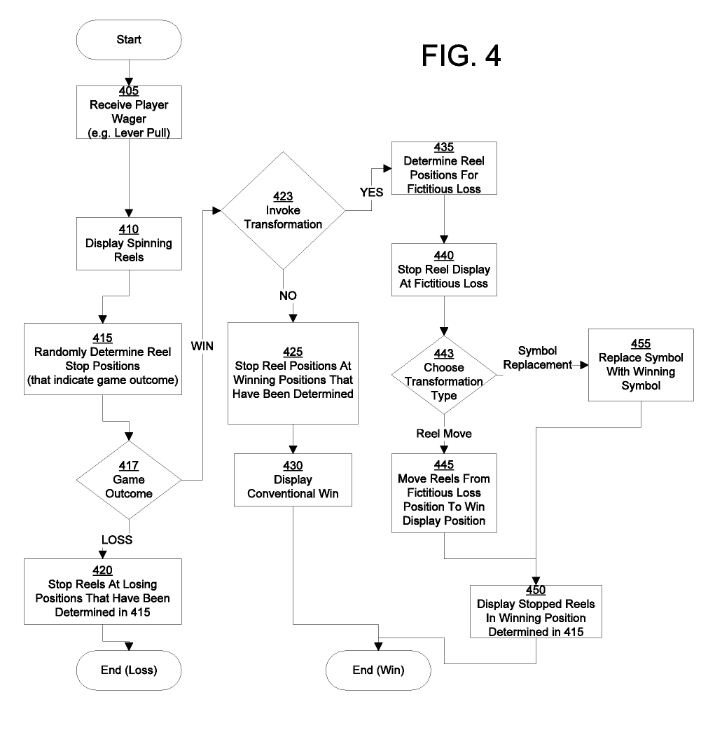

FIG. 4 illustrates an example procedure for facilitating the operation of a video slot machine game. This procedure may be provided, e.g., on a modified conventional video slot machine with additional software or firmware, on a video slot machine implemented using server based gaming where some or all of the actions are executed or controlled on a remote server, on personal computer game software or an Internet simulation of a slot machine displayed on a client device such as a personal computer, mobile phone, or personal digital assistant (PDA), or on other sorts of systems.

In 405, an indication may be received from the game player that a wager is to be placed and that the game should be initiated, e.g., the player may start the game by pulling a lever, pressing a button, or providing some other sort of signal or input.

In 410, spinning reels may be displayed to the player, e.g., as an animation on a video slot machine screen. While the spinning reels are being displayed, in 415, a random stop position for each reel may be determined, e.g., using a software, firmware, or hardware, random number generator on the slot machine. It will be appreciated that, in some example procedures, this determination may also be made before the slot machine begins to spin.

In 417, depending on the game outcome, flow of control may be altered. If the game outcome is a loss, in 420, the spinning reels may be displayed as stopping in a losing position and the game ends in a loss. Otherwise in 423, the game is a win and the procedure in continues. In 423 a decision as to whether to invoke an enhanced win presentation, such as the visual transformation of a fictitious loss, may be made. This trigger may be a simple random number outcome equivalent to a coin flip, a predetermined weighted probability, or a complicated function based on a variety of factors and information, such an elapsed time since a prior event, a quantity of wagers placed since a prior event, a quantity of wagers placed since a prior event exceeding a predetermined threshold, a total amount waged since a prior event, a total amount waged since a prior event exceeding a predetermined threshold, a quantity of prizes won since a prior event, a quantity of prizes won since a prior event exceeding a predetermined threshold, a total amount of prizes won since a prior event, a total amount of prizes won since a prior event exceeding a predetermined threshold, the size of the prize for the winning game outcome, the size of a prize for the winning game outcome exceeding a predetermined threshold, winning a progressive prize that is awarded depending on the result of the base game or independent of the base game, a random outcome separate from the regular determination of the game outcome, or the occurrence of a bonus game trigger for a conventional bonus game. These triggers may be used alone, or in various combinations with each other or other information or factors. In 430, assuming no enhanced presentation is triggered, the winning outcome may be presented conventionally, e.g., by stopping the reels at the determined slot machine reel positions representing the appropriate winning outcome. In this case, the particular play of the game ends in a win, with a payout to the player corresponding to the winning game outcome which is represented by the final reel positions in accordance with the rules of the particular game.

In 435, an enhanced presentation such as the presentation of a fictitious loss is triggered. The reel positions for the fictitious loss may be determined. In 440, the reels may be stopped at the determined position representing the loss (or in a variation at a lower value outcome than what has actually been won). In 443, (or alternatively before the display of the fictitious loss) the appropriate type of transformative display may be chosen. For example, in 445, the transformation may be a movement of the reels; one or more of the reels may restart, jump, or bump to a different position, so that the reel positions representing the winning outcome are obtained. This may be done in any of a variety of entertaining ways—e.g., with sound effects simulating a mechanical machine failure, by an animated character (illustrated below), or in any other manner. In 455, a symbol may be replaced by a different symbol. Again, this may be accomplished in any visually entertaining manner. In 450, the final stopped position of the reels corresponding to the winning outcome is displayed, and the play ends in a win with a payout to the player.

It will be appreciated that the various decision points in the above example procedure may be simplified, or made more complex. They also may all be done in advance, or as needed. The various determinations may be made on a game terminal, or under control of a server.

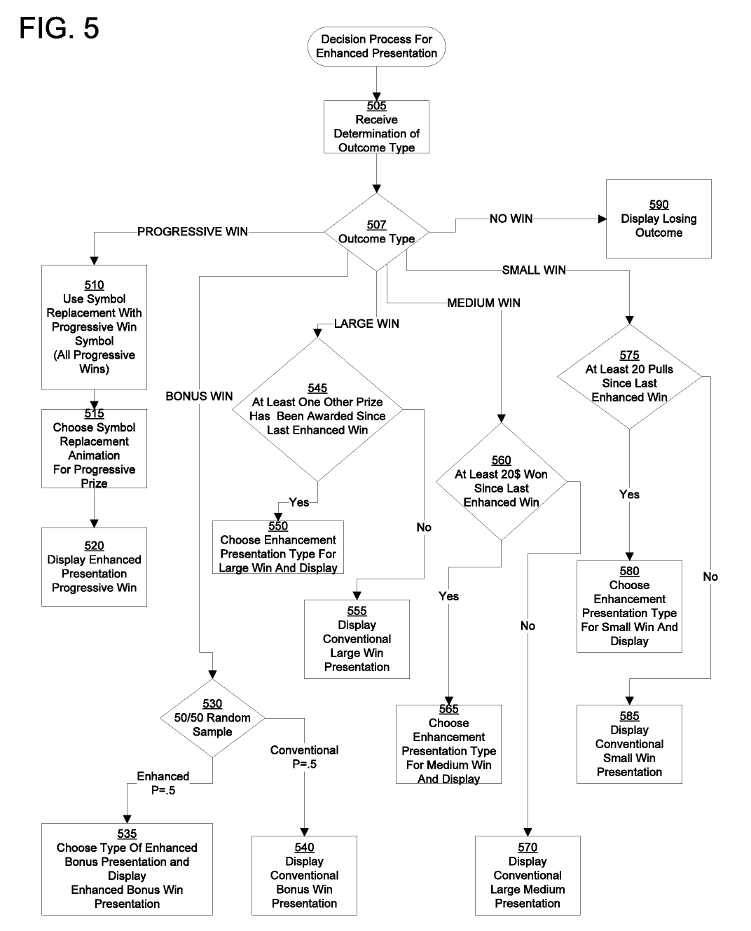

FIG. 5 illustrates a more detailed example procedure for determining whether an enhanced presentation is to be presented and the form the enhanced presentation may take. It will be appreciated that this is merely exemplary, and a wide variety of alternative approaches to determining whether and how enhanced presentations are made may be provided.

In 505, the game outcome determination may be received. The procedure then varies depending on the particular type of game outcome, with flow of control changing depending on the game outcome 507

If there has been a progressive win, in 510 a symbol replacement algorithm may be used to provide a particular progressive win symbol onto the display. The use of an enhanced win presentation with a fictitious loss may be used, in this example, for all progressive game wins. In 515 the particular symbol and animation of symbol replacement representing the progressive win may be chosen, and in 520 the representation of the progressive win may be displayed using the chosen symbol and animation.

If there has been a bonus win, determined separately from the position of the reels, in 530 a binomial random sample may be used to decide whether to display the bonus win conventionally or in an enhanced manner, such as with a fictitious loss. It will be appreciated that other types of bonus triggers may be used, tied, e.g., to elapsed time, player tracking or player loyalty program statistics, or other parameters. In 535, a type of display to represent the bonus game or the bonus game trigger may be chosen. For example the fictitious win may be displayed, and a symbol replaced with a bonus game trigger system, similar to what was described above for a progressive win. Alternatively, if particular combination of symbols trigger a bonus, the reels could be bumped or moved to achieve that position after the display of the fictitious loss. In 540, the bonus win may be displayed conventionally, without the enhancement provided by a fictitious loss display.

In 545, for large wins, e.g., all conventional wins greater than a first threshold such, e.g., $100, an enhanced presentation may be triggered if at least one other prize (or alternatively some larger quantity of prizes) has been awarded since the last time a win was awarded with an enhanced presentation using a fictitious loss. This may help keep the player excited about the enhanced presentations, by avoiding too much repetition. In 550, the particular enhancement presentation type, e.g., reel bump or symbol replacement, may be chosen, and subsequently displayed. Alternatively, in 555, the large win may be presented conventionally.

In 560, for medium wins, e.g., all conventional wins smaller than the first threshold but greater than a second smaller threshold, e.g., $20-$100, an enhanced presentation using a fictitious loss may be triggered if at least a certain amount of prize money, e.g., $20 has been won since the last time an enhanced win was displayed. In 565, the particular enhanced presentation may be chosen and used to display the medium value win. In 570, a conventional display may be used to present the medium win.

In 575, for small wins, e.g., smaller than the second threshold, e.g., less than $20, the enhanced presentation may be used if at least 20 pulls have occurred since the last enhanced win. In 580, the particular enhanced win presentation type may be chosen and displayed for the small win. Alternatively, in 585, the small win may be displayed in a conventional manner.

In 590, for losing outcomes, no enhanced presentation is provided in this example; accordingly the presentation may be presented as a conventional display of a losing outcome.

It will be appreciated that the example in FIG. 5 has been provided merely to give some illustrative examples of the types of triggering mechanisms that may be used in deciding whether and how to display an enhanced win using a fictitious loss. An effectively infinite variety of different options may be provided, e.g., by coding alternative software, or by providing parameters that control the game software that can be set by the entity offering the game to achieve various desired flows of control. It will also be appreciated that a wide range of different animations may be provided in order to transform the fictitious losing outcomes in the determined winning outcomes.

FIGS. 6A-6H illustrate various approaches to using an animated character to provide a visual transformation of a game outcome, according to an example embodiment of the present invention. It will be appreciated that a wide variety of various themes may be employed, in order to make the games appealing to various player demographics.

FIG. 6A illustrates an example slot machine game screen 610, where an animated character 612 appears to strike the reels with a hammer, causing the stopped reels to move to a new position. FIG. 6B illustrates game screen 620, where animated character 622 uses a simulated jack to appear to move the reel position on one of the reels of the game display. FIG. 6C illustrates game screen 630, where animated character 632 appears to fly across the game screen and deposit a new game symbol in a selected position. FIG. 6D illustrates game screen 640, where animated character 642 does not alter the game screen 640 symbol display, but instead announces a new game outcome, possibly one different than that indicated by the underlying game screen. FIG. 6E illustrates game screen 650, where animated character 652, uses a pencil to erase and or re-write game symbols to produce a new game symbol, changing the original display, to a new display representing the game outcome. For example, the symbol 653 is transformed into a different bonus symbol. The character may use other objects, such as a whirlwind 658 that appears to be part of the symbol alteration. FIG. 6F illustrates game screen 660, where animated character 662, uses a weapon, such as a ray gun to destroy or alter a symbol and produce a new screen representing the winning outcome. FIG. 6G illustrates game screen 670, where animated character 672, appears to actually manipulate a symbol 674, causing it to appear to spin and reveal, upon stopping, its opposite side with a symbol 676. In FIG. 6H, the animated character 682 appears to actually knock the symbol 684 loose from the screen and to repair the screen by replacing the symbol with a new symbol 686.

It will be appreciated that the above example animations are merely exemplary, and a vast quantity of different forms of animation may be used as alternatives.

### Conclusion

It will be appreciated that all of the disclosed methods, games, and procedures described herein can be implemented using one or more computer programs or components. These components may be provided as a series of computer instructions on any conventional computer-readable medium, including RAM, ROM, flash memory, magnetic or optical disks, optical memory, or other storage media. The instructions may be configured to be executed by a processor which, when executing the series of computer instructions, performs or facilitates the performance of all or part of the disclosed methods, games, and procedures.

It should be understood that there exist implementations of other variations and modifications of the invention and its various aspects, as may be readily apparent to those of ordinary skill in the art, and that the invention is not limited by specific embodiments described herein. Features and embodiments described above may be combined. It is therefore contemplated to cover any and all modifications, variations, combinations or equivalents that fall within the scope of the basic underlying principals disclosed and claimed herein.

It will be appreciated that, in the above descriptions, reference has been made to “random numbers” and “random number generation.” It will be appreciated that this recitation includes both random sampling of physical events, the use of a computer software pseudo random number generator, a firmware or hardware random or pseudo random number generator, or the reference to external real world events that are effectively random for the purposes of the game, e.g., the least significant digit in the total trading volume on a stock exchange. Access may also be provided to a secure random number generator outside the system itself, e.g., a utility or service that provides the results of random external events, such as ball drawings used in conventional Lotto type games or pseudo-random numbers generated on another computer system, or access to other information that while not technically random, is unknowable in advance and effectively random for the purpose of the game, e.g., reference to particular sports or financial information, such as the last (least significant) digit in the total stock sales on the New York stock exchange, or the last (least significant) digit of the total number of pitches thrown in all the major league baseball games on a particular day. Where “random numbers” are referred to in the present application, it should be understood, unless expressly indicated otherwise, that any of the above approaches to random number generation are intended to be included. It is also appreciated that, the random numbers can be used to determine game outcomes; however, the determination, unless specifically required by the language of the claims need not be done in any particular location, it may be on a dedicated machine, a server, accessed over a network, etc.

The terms “a” and “an” and “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”, “in the case”, “by way of example”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability.

Example embodiments of this invention are described herein, including the best mode known to the inventors for carrying out the invention. Of course, variations on those example embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

In closing, it is to be understood that the example embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described in the specification.

1. A method of facilitating the operation of a wagering game, comprising:
randomly determining whether a game play has a winning game outcome; and
conditioned on the game play having a winning game outcome, displaying the winning game outcome to the player by displaying a first display representing a fictitious loss, and after displaying the first display representing a fictitious loss, visually transforming the first display representing a fictitious loss into a second display representing the winning outcome.

2. The method of claim 1, further comprising:
prior to displaying the first display, displaying an animated simulation of a plurality of spinning reels having a plurality of symbols thereon, each possible stopped position of the plurality of spinning reels having a corresponding game outcome; and
as part of displaying the first display, displaying a stopped position of the plurality of spinning reels corresponding to the fictitious loss.

3. The method of claim 2, further comprising:
after displaying the stopped position of the plurality of spinning reels corresponding to the fictitious loss and as part of the visually transforming, moving the plurality of spinning reels from the stopped position corresponding to the fictitious loss to a second stopped position in the second display corresponding to the winning game outcome.

4. The method of claim 2, further comprising:
after displaying the stopped position of the plurality of spinning reels corresponding to the fictitious loss and as part of the transforming, replacing at least one of the symbols on one of the stopped reels in the first display, the replacement yielding a second stopped position of the reels in the second display corresponding to the winning game outcome.

5. The method of claim 4, wherein the position of the reels is not changed during the transforming.

6. The method of claim 2, further comprising:
prior to displaying the first display and as part of randomly determining whether the game play has a winning outcome, randomly determining the stopping position of the plurality of spinning reels in the second display, and
stopping the spinning reels at a position other than the determined stopping position as part of displaying the first display.

7. The method of claim of claim 1, further comprising:
responsive to determining that the game outcome is a winning outcome, determining whether to display the winning game outcome directly or to display the winning game outcome by visually transforming a losing game outcome display; and
responsive to determining that the winning game outcome should be displayed directly, displaying the winning game outcome without displaying the first display.

8. The method of claim 7, wherein the determining whether to display the winning game outcome directly or to display the winning game outcome by visually transforming a losing game outcome display is based at least in part on a random selection using a predetermined probability independent of the random determination of the game play outcome.

9. The method of claim 7, wherein the determining whether to display the winning game outcome directly or to display the winning game outcome by visually transforming a losing game outcome display is based at least in part on at least one of an elapsed time since a prior event, a quantity of wagers placed since a prior event, a quantity of wagers placed since a prior event exceeding a predetermined threshold, a total amount waged since a prior event, a total amount waged since a prior event exceeding a predetermined threshold, a quantity of prizes won since a prior event, a quantity of prizes won since a prior event exceeding a predetermined threshold, a total amount of prizes won since a prior event, a total amount of prizes won since a prior event exceeding a predetermined threshold, a size of the prize for the winning game outcome, a size of a prize for the winning game outcome exceeding a predetermined threshold, winning a progressive prize awarded independently from a prize for the winning game outcome, or a random outcome separate from the determination of the game outcome, the occurrence of a winning game outcome including a special symbol, or the occurrence of a bonus game trigger.

10. The method of claim 1, wherein the visually transforming further comprises:
displaying an animated character that appears to cause the transformation of the first display into the second display.

11. The method of claim 1, wherein the display of the winning game outcome to the player by displaying a first display representing a fictitious loss is conditioned on the winning outcome being of at least a predetermined minimum size.

12. A method of facilitating the operation of a wagering game, comprising:
randomly determining a base game outcome;
displaying to a player a first display including an arrangement of a plurality of symbols representing the base game outcome;
randomly determining a bonus prize should be awarded; and
after displaying the first display, informing the player of the bonus prize award by altering at least a subset of the plurality of symbols in the first display to form a second display representing the bonus game outcome.

13. The method of claim 12, wherein the altering includes replacing at least one symbol in the plurality of symbols with another symbol.

14. The method of claim 12, wherein the altering includes moving the positions of at least a subset of the plurality of symbols.

15. The method of claim 12, wherein the first display represents an outcome where the bonus prize is not awarded.

16. The method of claim 15, wherein the first display represents a winning outcome.

17. The method of claim 12, wherein a game display is an animated simulation of spinning reels, the positions of the spinning reels when the reels stop correspond to game outcomes, and the altering includes turning the spinning reels from a first stop position corresponding to the base game outcome to a second stop position corresponding to the bonus winning outcome.

18. The method of claim 17, wherein the reels appear to the player to be moved from the first stop position to the second stop position by an animated character.

19. The method of claim 12, further comprising,
awarding the player both the prize associated with the base game outcome and the bonus prize.

20. The method of claim 1, wherein the game is a simulation of a card game.

21. A method of facilitating the operation of a wagering game, comprising:
randomly determining a game outcome;
determining whether to present the game outcome as a natural presentation or an enhanced presentation; and
conditioned on the game outcome being a win and the presentation of the game outcome being the enhanced presentation, presenting a first display representing a first fictitious game outcome of lower value than the game outcome, and visually transforming the first display into a second display representing the game outcome.

22. The method of claim 22, wherein the first fictitious game outcome is a loss.

23. The method of claim 22, wherein the enhanced presentation includes the display of an animated character that appears to change the game outcome from the fictitious game outcome to the game outcome.

24. The method of claim of claim 21, further comprising:
responsive to determining that the game outcome is a winning outcome, determining whether to display the natural presentation of the winning game outcome or to display an enhanced display of the winning game outcome by visually transforming a lesser game outcome display; and
responsive to determining that the natural presentation of the winning game outcome should be displayed, displaying the winning game outcome without displaying the first display.

25. The method of claim 24, wherein the determining whether to display the natural presentation of the winning game outcome or to display an enhanced display of the winning game outcome by visually transforming a lesser game outcome display is based at least in part on a random selection using a predetermined probability independent of the random determination of the game outcome.

26. The method of claim 24, wherein the determining whether to present the game outcome as an enhanced presentation is based at least in part on at least one of an elapsed time since a prior event, a quantity of wagers placed since a prior event, a quantity of wagers placed since a prior event exceeding a predetermined threshold, a total amount wagered since a prior event, a total amount wagered since a prior event exceeding a predetermined threshold, a quantity of prizes won since a prior event, a quantity of prizes won since a prior event exceeding a predetermined threshold, a total amount of prizes won since a prior event, a total amount of prizes won since a prior event exceeding a predetermined threshold, a size of the prize for the winning game outcome, a size of a prize for the winning game outcome exceeding a predetermined threshold, winning a progressive prize awarded independently from a prize for the winning game outcome, or a random outcome separate from the determination of the game outcome, an occurrence of a bonus game trigger.

27. A system for facilitating the play of a wagering game, comprising:
a randomization device configured to generate a random result;
a display configured to display images representing game outcomes to a player; and
a processor in communication with the display and the randomization device, the processor configured to determine the game outcomes based on the random results received from the randomization device, and for at least a fraction of winning game outcomes, to cause the display to display a representation of the fictitious losing outcome, and after the representation of a fictitious losing outcome has been displayed, to visually transform the display of the fictitious losing outcome into a display representing the winning game outcome.

28. The system of claim 27, further comprising:
an input device configured to receive a wager amount from a player;
the processor further configured to receive information from the input device indicating the wager amount and to determine a prize based at least in part on the game outcome and the wager amount.

29. The system of claim 27, wherein the processor is further configured to determine whether to display an enhanced presentation upon the occurrence of a win, and, responsive to the determination to display an enhanced presentation, to cause the display to display the enhanced presentation.

30. The system of claim 29, wherein the processor is further configured during the enhanced presentation:
to cause the display to display a display corresponding to a fictitious losing game outcome and to visually transform the display corresponding to the fictitious losing game outcome into a display corresponding to the winning game outcome.

31. The system of claim 27, further comprising:
a storage device storing animation information, wherein the processor is further configured to use the animation information from the storage device to display an animated character as the apparent cause of the visual transformation of the display corresponding to the fictitious losing outcome into the display corresponding to the winning game outcome.

32. The system of claim 31, wherein the game outcome is represented by a stopping position of a set of animated spinning slot machine reels.

33. The system of claim 30, wherein the visual transformation is at least one of moving a stopped slot machine reel or replacing a symbol on a slot machine reel with another symbol.

34-41. (canceled)
